(19) United States
(12) Patent Application Publication
(10) Pub. No.: US 2009/0228884 A1
(43) Pub. Date: Sep. 10, 2009

(54) NETWORK INTERFACE ENGINE

(76) Inventors: Benedict T. Chong, San Jose, CA (US); Philip Sheu, San Jose, CA (US); Victor E. Chin, San Jose, CA (US)

Correspondence Address: GLENN PATENT GROUP, 3475 EDISON WAY, SUITE L, MENLO PARK, CA, 94025, US

(21) Appl. No.: 12/398,945

(22) Filed: Mar. 5, 2009

Related U.S. Application Data
(60) Provisional application No. 61/034,096, filed on Mar. 5, 2008.

(51) Int. Cl. G06F 9/455; G06F 15/177

(52) U.S. Cl. 718/1; 713/2

(57) ABSTRACT

A network interface engine enables a pre-boot environment that has very limited networking hardware interface support to be able to use to a broad range of physical network interfaces. The network interface engine is an operating system that includes device driver support for various networking hardware interfaces such as different LAN, WLAN, and WWAN chipsets. The hypervisor establishes a virtual network interface between the pre-boot environment and the network interface engine, which enables the pre-boot environment to use one standard network interface to access the wide variety of networking hardware interfaces.

### CROSS REFERENCE TO RELATED APPLICATIONS

This patent application claims the benefit of U.S. provisional patent application Ser. No. 61/034,096, Method and Apparatus for Virtualization, filed Mar. 5, 2008, the entirety of which is incorporated herein by this reference thereto.

### BACKGROUND OF THE INVENTION

1. Technical Field

This invention relates generally to the field of virtualization environments. More specifically, this invention relates to an intermediate between a pre-boot environment, an operating system with full support of networking hardware, and a hypervisor.

2. Description of the Related Art

Computers contain an operating system (OS) that serves as an interface between hardware and applications running on the computer. To put it simply, the OS manages the computer resources for the applications. Traditional operating systems, such as Microsoft® Windows, are slow to load. Furthermore, these operating systems are written for native hardware architecture and are incompatible with computer programs that were written for other architectures. As a result, computer programs were developed to resolve these incompatibilities.

An operating system that does not directly interact with computer hardware is referred to as a virtual machine because its hardware interface is represented entirely in software, or “virtual.”

A traditional operating system accesses networks, e.g. the Internet by using a driver to interact with a network interface controller, which uses both a physical layer and a data link layer for accessing physical networks. A physical network can be a local area network (LAN), e.g. Ethernet, a wireless local area network (WLAN), e.g. Wifi, or wireless wide area network (WWAN), e.g. 2G, 3G, 4G.

### SUMMARY OF THE INVENTION

In the context of this patent application, a pre-boot environment is defined as a user-accessible software environment that is available before the host OS boots. The host OS is commonly a full-featured OS such as Microsoft® Windows. The pre-boot environment may be a Basic Input/Output System (BIOS)-based application, a Unified Extensible Firmware Interface (UEFI)-based application, an embedded OS along with applications, or a small-footprint Linux OS along with applications.

Pre-boot environments such as BIOS, UEFI, or an embedded OS contain very limited support for network interfaces because device drivers are difficult and time consuming to generate. On the other hand, device drivers for various network interfaces are readily available on an OS such as Linux, covering network media such as LAN, WLAN, and WWAN. Via virtualization, the pre-boot environment can gain access to a wide range of network interfaces without having its own device drivers, by leveraging an OS with broad networking hardware support. The OS with the networking hardware support directly interfaces to the networking hardware chipsets and provides a virtual network interface to the pre-boot environment.

In one embodiment, a network interface engine serves as an intermediary between the pre-boot environment and the network interface hardware (LAN, WLAN, or WWAN chipsets). In one embodiment, the network interface engine comprises the Linux OS and, therefore, uses Linux network device drivers to interact with networking hardware. In one embodiment, the network interface engine functions as an intermediary for a pre-boot environment until other operating systems are launched. In another embodiment, the network interface engine is used by the co-resident pre-boot environment and other operating systems in the virtualized environment.

### BRIEF DESCRIPTION OF THE DRAWINGS

FIG. 1 is a block diagram that illustrates a client for running a virtualized environment according to one embodiment of the invention;

FIG. 2 is a block diagram that illustrates a system for enabling a pre-boot environment to access the physical networking hardware via a virtual network interface provided by the network interface engine, according to one embodiment of the invention;

FIG. 3 is a block diagram that illustrates the components for booting for a virtualized environment according to one embodiment of the invention; and

FIG. 4 is a flow diagram that illustrates the booting process implemented by the components illustrated in FIG. 3 according to one embodiment of the invention.

### DETAILED DESCRIPTION OF THE INVENTION

In one embodiment, the invention comprises a method and an apparatus for using virtualization to enable universal network access on a pre-boot environment that typically has very limited networking hardware support.

Hardware

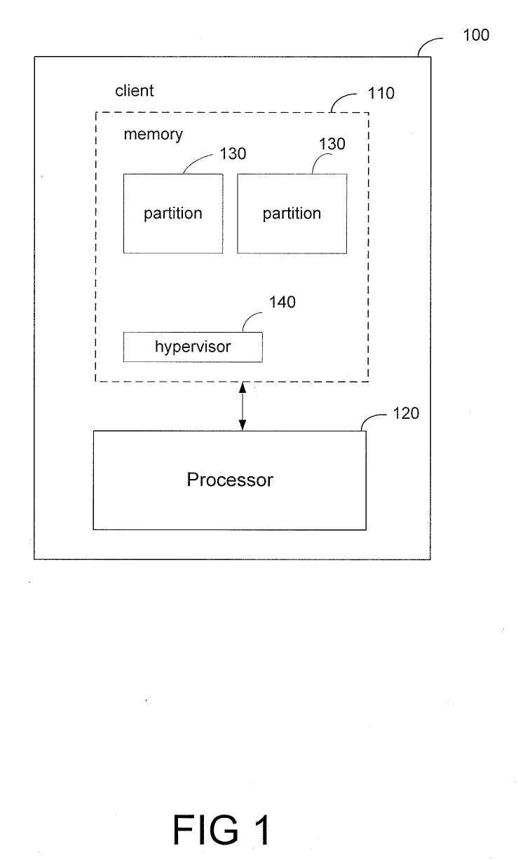

FIG. 1 is a block diagram that illustrates the hardware partitioning for a virtualized environment according to one embodiment of the invention. The client 100 comprises a computing platform configured to act as a client device, e.g. a computer, a digital media player, a personal digital assistant, an Internet appliance, etc. The client 100 may include a number of external or internal devices, e.g. a mouse, a keyboard, a display device, etc.

The client 100 includes a computer-readable storage medium, i.e. memory 110. The memory includes, but is not limited to, for example random access memory (RAM), an electronic, optical, magnetic, or other storage or transmission device capable of coupling to a processor, e.g. flash drive, CD-ROM, DVD, magnetic disk, memory chip, ROM, etc. The memory 110 is coupled to a processor 120, which executes computer-executable program code stored in the memory 110. In a client 100 that runs in a virtualized environment, the memory and other hardware are logically partitioned 130 to support, for example, different operating systems. Each partition executes in a separate memory space. In one embodiment of the invention, memory and hardware are virtualized and shared.

A hypervisor 140, which is also known as a virtual machine monitor, allocates system resources to provide each OS with the appearance of having its own partitioned memory 130, processor, and hardware or firmware resources. The hypervisor 140 is illustrated as being within the memory 110, however, in another embodiment, the hypervisor 140 is implemented within hardware or firmware.

System Components

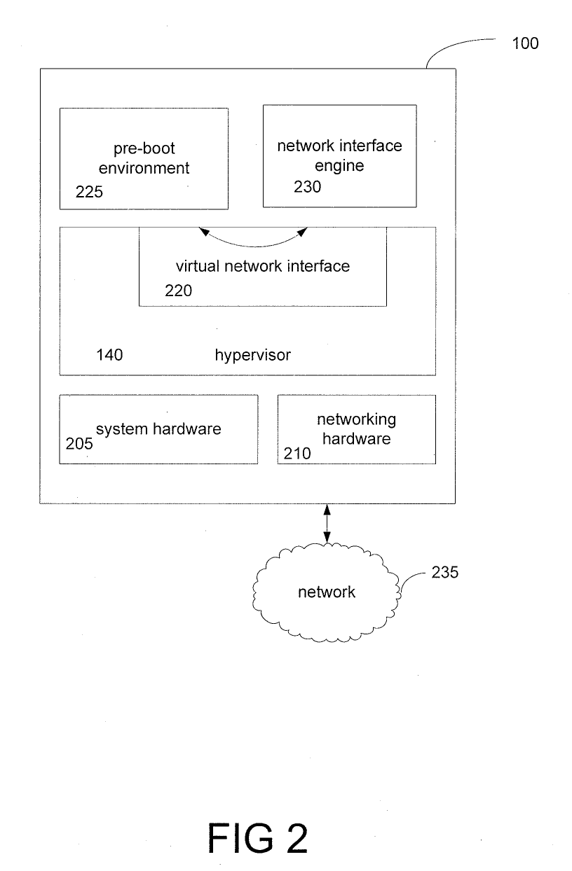

FIG. 2 is a block diagram that illustrates a system for enabling a pre-boot environment to access the physical network via a virtual network interface, according to one embodiment of the invention.

Computer hardware is represented by system hardware 205 and networking hardware 210 (Ethernet controllers, Wifi chipsets, 3G modules, etc.). The hypervisor 140 manages hardware access by the virtual machines. There are two virtual machines shown: a pre-boot environment 225 and a network interface engine 230. The network interface engine 230 is responsible for physical network access; therefore, the hypervisor 140 grants it direct access to networking hardware 210. The pre-boot environment 225 is the software environment that a user can interact with via input devices and a display; therefore, the hypervisor 140 grants it access to most of the system hardware 205.

The hypervisor 140 helps to establish a virtual network interface 220 between the two virtual machines. The network interface engine 230 makes its network connectivity available to the pre-boot environment 225 via the virtual network interface 220. This enables the pre-boot environment 225 to implement a single network interface that matches the virtual network interface 220, yet it can effectively make use of a wide range of network hardware interfaces (LAN, WLAN, WWAN chipsets by different manufacturers) by virtue of the diverse driver support in the network interface engine 230.

When the pre-boot environment 225 needs to access the network 235, it uses the standard interface on the virtual network interface 220. In one embodiment, the virtual network interface 220 is a software implemented communication channel. In another embodiment, the virtual network interface 220 is an emulated standard Ethernet controller. The network interface engine 230 in turn bridges the access to its networking hardware device drivers, which communicate directly with the networking hardware 210 to get onto the network 235.

The virtual network interface 220 can be implemented as an application programming interface (API) or a socket-based interface that establishes a communication channel between the pre-boot environment 225 and the network interface engine 230 with the help of the hypervisor 140. In one embodiment, the virtual network interface 220 is implemented as an emulation of a standard, well-known Ethernet controller interface. In this case, the pre-boot environment 225 only needs to implement one network device driver. Through the network interface engine 230, the single network device driver can access a broad range of network hardware interfaces.

Parameters of the network interface (e.g. Wifi access point IDs, Wifi access point passwords, 3G login, etc.) can be configured by the user via a simple application in the pre-boot environment 225 or with the network interface engine 230. These parameters can be stored in a persistent storage area accessible by the network interface engine 230.

Flow Chart

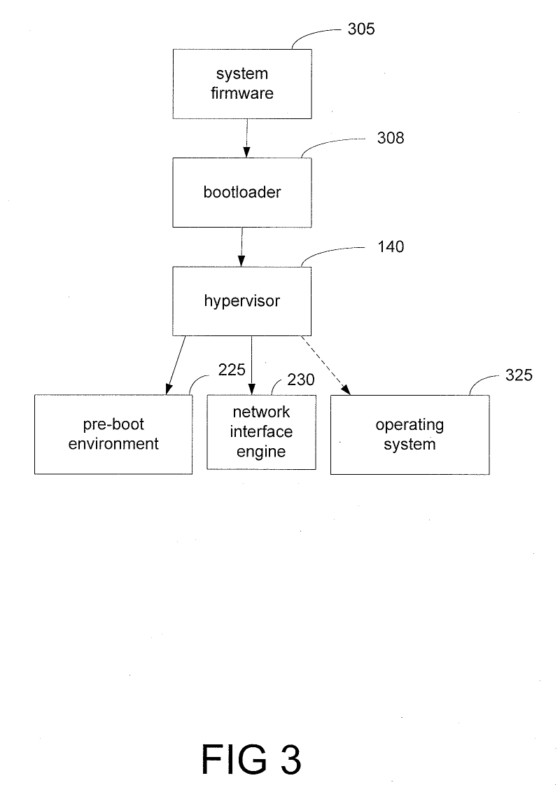

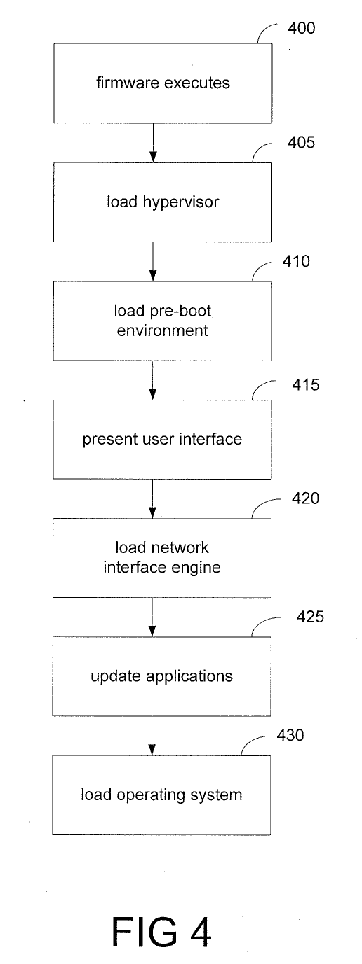

FIG. 3 is a block diagram that illustrates the booting process for a virtualized environment, according to one embodiment of the invention. FIG. 4 is a flow diagram that illustrates the steps for booting a virtualized environment using the components in FIG. 3 according to one embodiment of the invention.

When the system is first turned on, system firmware 305 executes 400. System firmware 305 is usually either BIOS or UEFI. System firmware 305 hands control over to the bootloader 308, which then loads 405 the hypervisor 140. The hypervisor 140 first loads 410 the pre-boot environment 225, which can be a BIOS application, UEFI application, or an embedded OS. The pre-boot environment 225 presents 415 the user interface. The user interface can include various static or network-based applications (e.g. stock ticker, weather, e-mails, calendar events, RSS feeds, clock, photos, etc.).

In parallel, the hypervisor 140 can load 420 the network interface engine 230. When the network interface engine 230 is loaded, the virtual network interface 220 will be ready for use by the pre-boot environment 225. The pre-boot environment 225 can then update 425 its network-based applications with live data from the Internet (e.g. updated stock prices, new e-mails, etc.).

In some embodiments of the invention, the hypervisor 140 may load 430 yet another operating system virtual machine 325 that accesses the network through the network interface engine 230. In this case, the virtual network interface 220 bridges the physical network hardware to two virtual machines, a pre-boot environment 225 and an operating system 325.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

What is claimed is:

1. A system for using virtualization to enable broad network access on a pre-boot environment with limited networking hardware support, the system comprising:
a processor;
a memory comprising at least two partitioned memory areas that are accessible by said processor during operation of said pre-boot environment;
a bootloader for launching a hypervisor;
said hypervisor for managing loading and launch of a pre-boot environment and a network interface engine by allocating system resources, including said partitioned memory, for each of said pre-boot environment and said network interface engine;
said pre-boot environment comprising a user interface and applications;
said network interface engine comprising an operating system with broad network hardware interface support for bridging network access between said pre-boot environment and a physical network hardware interface; and
said network hardware interface for communicating with an external network.

2. The system of claim 1, wherein said pre-boot environment comprises one of a Basic Input/Output System application, Unified Extensible Firmware Interface application, an embedded operating system with applications, and a Linux operating system with applications.

3. The system of claim 1, wherein said external network comprises one of a local area network, a wireless local area network, and a wireless wide area network.

4. The system of claim 1, wherein said hypervisor further comprises a virtual network interface that interfaces with said pre-boot environment to route requests to said network interface engine.

5. The system of claim 4, wherein said hypervisor loads multiple pre-boot environments or operating system virtual machines, said network interface engine providing said virtual network interface to all of said virtual machines.

6. The system of claim 1, wherein said virtual network interface comprises a software-implemented communication channel or an emulated standard Ethernet controller that interfaces with said pre-boot environment to route requests to said network interface engine.

7. The system of claim 1, wherein said user interface displays at least one static or network-based application.

8. The system of claim 1, wherein a physical network is configured using an application in at least one of said pre-boot environment and said network interface engine.

9. The system of claim 1, further comprising:
a persistent storage for storing network configuration information.

10. The system of claim 9, wherein said network interface engine retrieves network configuration information from said persistent storage.

11. A computer-implemented method for using virtualization to enable broad network access on a pre-boot environment with limited networking hardware support, the method comprising the steps of:
a system firmware executing, said system firmware handing control over to a bootloader;
said bootloader loading a hypervisor;
said hypervisor allocating system resources for loading a pre-boot environment;
said pre-boot environment displaying a user interface comprising at least one static or network-based application;
said hypervisor allocating system resources for loading a network interface engine;
said network interface engine bridging network access between said pre-boot environment and a physical network; and
a network hardware interface communicating with an external network to retrieve data for said network interface engine.

12. The method of claim 11, further comprising the step of:
said network interface engine updating any network-based applications.

13. The method of claim 11, further comprising the steps of:
said hypervisor loading an operating system virtual machine; and
said operating system virtual machine accessing said network through said network interface engine.

14. The method of claim 11, further comprising the step of:
a virtual network interface routing requests from said pre-boot environment to said network interface engine.

15. The method of claim 11, further comprising the steps of:
storing network configuration information in persistent storage; and
said network interface engine retrieving network configuration information from said persistent storage.

16. The method of claim 11, further comprising the step of:
configuring at least one parameter of said network interface through an application in at least one of said pre-boot environment and said network interface engine.

17. The method of claim 11, wherein said pre-boot environment comprises one of a Basic Input/Output System application, Unified Extensible Firmware Interface application, an embedded operating system with applications, and a Linux operating system with applications.

18. The method of claim 11, wherein said external network comprises one of a local area network, a wireless local area network, and a wireless wide area network.

19. The method of claim 11, wherein said virtual network interface comprises a software-implemented communication channel or an emulated standard Ethernet controller that interfaces with said pre-boot environment to route requests to said network interface engine.

20. A computer-implemented method for using virtualization to enable broad network access on a pre-boot environment with limited networking hardware support, the method comprising the steps of:
a pre-boot environment requesting access to a network by interfacing with a virtual network interface;
a hypervisor granting said virtual network interface access to a network interface engine, said virtual network interface engine communicating with a network interface engine to access said network;
said network interface engine using a network device driver to access a hardware network to fulfill said request from said pre-boot environment.
